(19) United States
(12) Patent Application Publication
(10) Pub. No.: US 2011/0109417 A1
(43) Pub. Date: May 12, 2011

(54) POWER TRANSFORMER FOR RADIOFREQUENCY SIGNALS

(75) Inventors: Pierre Bertram, Jallais (FR); Charles Richardeau, Mortagne-Sur-Sevre (FR)

(73) Assignee: THALES, NEUILLY SUR SEINE (FR)

(21) Appl. No.: 12/988,957

(22) PCT Filed: Apr. 14, 2009
(86) PCT No.: PCT/EP09/54378

§ 371 Date: Jan. 19, 2011

(30) Foreign Application Priority Data
Apr. 22, 2008 (FR) 08 02247

(51) Int. Cl. H01F 5/00; H01F 19/00

(52) U.S. Cl. 336/200

(57) ABSTRACT

The present invention relates to a power transformer for radiofrequency signals. The transformer is made in a low-cost, multilayer printed circuit board comprising at least the following stacked layers in succession: a first conductive layer, a first layer of dielectric substrate, a second conductive layer, a second layer of dielectric substrate, and a third conductive layer, the primary winding being formed by a turn printed in the second conductive layer, the secondary winding being formed by a first turn printed in the first conductive layer, this first turn being connected to a second turn printed in the third conductive layer, the turns of the secondary winding being placed opposite to the turn of the primary winding, the board being tightly held above and below by two plates of ferromagnetic material. Capacitive components connected between winding(s) on the one hand and ground on the other hand can improve the behavior of the proposed transformer. The invention applies notably to the production of HF transmitting radioelectric terminals.

The present invention relates to a power transformer for radiofrequency signals. The invention applies notably to the production of HF transmitting radioelectric terminals.

Power transformers are usually made by wire coils on cores of ferromagnetic material. This craftwork production affects the cost of producing the transformer. In addition, other types of transformer, made with printed coils, have been proposed to make them easier to manufacture.

Notably, a planar transformer has been proposed by Motorola Inc in the American patent published under the reference U.S. Pat. No. 5,015,972. The planar transformer comprises two printed turns separated by a dielectric layer. Capacitors may also be positioned to interconnect two printed turns in order to improve the performance of the transformer in the operating frequency band. However, the structure of this transformer uses a heat-conducting substrate in order to dissipate the heat given off when it operates, making production complex and costly. Moreover, the proposed design of the windings causes a non-optimal coupling between said windings, which leads to losses of magnetic energy.

One object of the invention is to propose a high-frequency power transformer that is efficient—that is to say with low losses and controlling the impedances in the frequency band in question—and which can be simply incorporated into an electronic circuit in order to provide a function of impedance transformation at lower cost. Accordingly, the subject of the invention is a high-frequency power transformer comprising a primary winding and a secondary winding, characterized in that it is produced in a low-cost, multilayer printed circuit board, for example of the FR4 type (known to those skilled in the art), comprising at least the following stacked layers in succession: a first conductive layer, a first layer of dielectric substrate, a second conductive layer, a second layer of dielectric substrate, and a third conductive layer, the primary winding being formed by turns printed in the second conductive layer, the secondary winding being formed by a first half-winding printed in the first conductive layer, this first half-winding being connected to a second half-winding printed in the third conductive layer, the turns of the secondary winding being placed opposite to the turns of the primary winding, the widths of the turns of the windings being chosen as a function of the thicknesses of the layers of dielectric substrate, of the instantaneous-frequency band and of the power of the high-frequency signal passing through the transformer in order to minimize the losses and promote impedance-matching in the RF band in question, said board being tightly held above and below by two plates of ferromagnetic material. Therefore, the primary winding is tightly held by the secondary winding, the choice of the width of the lines and of the thickness of the layers of substrate making it possible to optimize the capacitive coupling between the windings.

According to one embodiment, an orifice is formed at the center of the printed board, the ferromagnetic block comprising two portions assembled to form a binocular block, each portion of said block occupying one side of the printed board, the first portion of said block being formed of an extruded E, the central branch of the E being inserted into the orifice formed at the center of the printed board, thus forming a magnetic core at the center of the windings, the second portion of said block being formed of a substantially flat plate. The presence of a magnetic core notably makes it possible to obtain a better concentration of the magnetic field.

According to one embodiment, at least one capacitor is connected between at least one turn of one of the windings, preferably the primary winding, and an electric ground in order to improve the behavior of the transformer with respect to the impedances that it presents in the RF band in question. The presence of this (these) capacitor(s) makes it possible to better control the impedances presented by said winding in the RF band relative to the surrounding components, for example power transistors connected at the input of the transformer, particularly in the high frequencies of the operating frequency band. The value of capacitance is chosen as a function of the mounting of the amplifier using this RF transformer.

According to one embodiment, the portions of the ferromagnetic block are made of ferrite and have standard dimensions thus allowing a production of the transformer at low cost.

According to one embodiment, the transformer is capable of operating for high-frequency signals in an instantaneous-frequency band between 1 MHz and several tens of MHz, preferably 1 to 50 MHz.

Moreover, the transformer according to the invention is capable of operating at high powers, of the order of 1 Watt to several tens of Watts.

Moreover, the widths of the turns of the windings are chosen as a function of the operating frequency band of the transformer.

A further subject of the invention is a radioelectric power transmitter board comprising a transformer as described above.

Other features will appear on reading the following nonlimiting detailed description that is given as an example with respect to the appended drawings which represent:

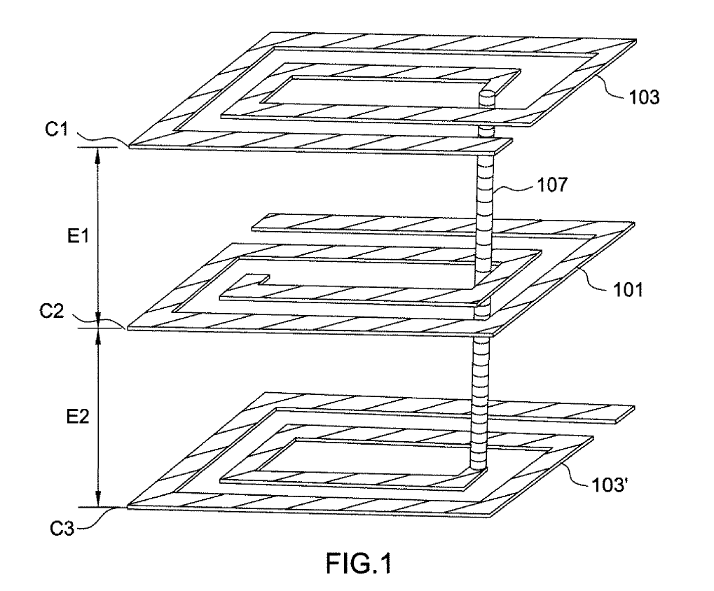

FIG. 1, an illustration of a windings structure used in the power transformer according to the invention;

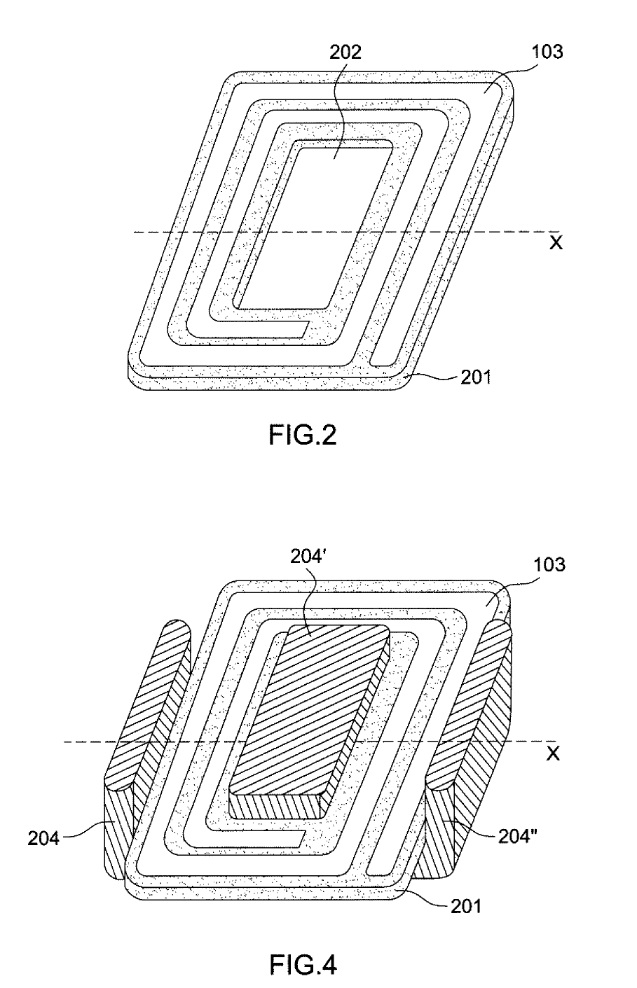

FIG. 2, a top view of a printed circuit used in a transformer according to the invention;

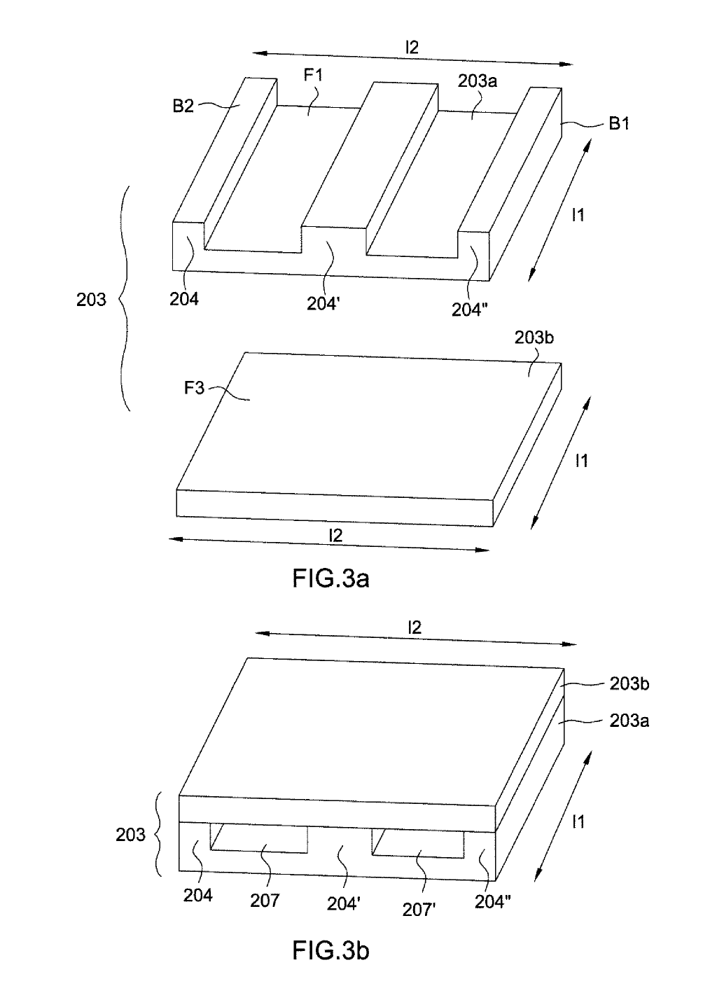

FIGS. 3a and 3b, an example of a block of ferromagnetic material included in the transformer according to the invention;

FIG. 4, a view in perspective of a transformer according to the invention;

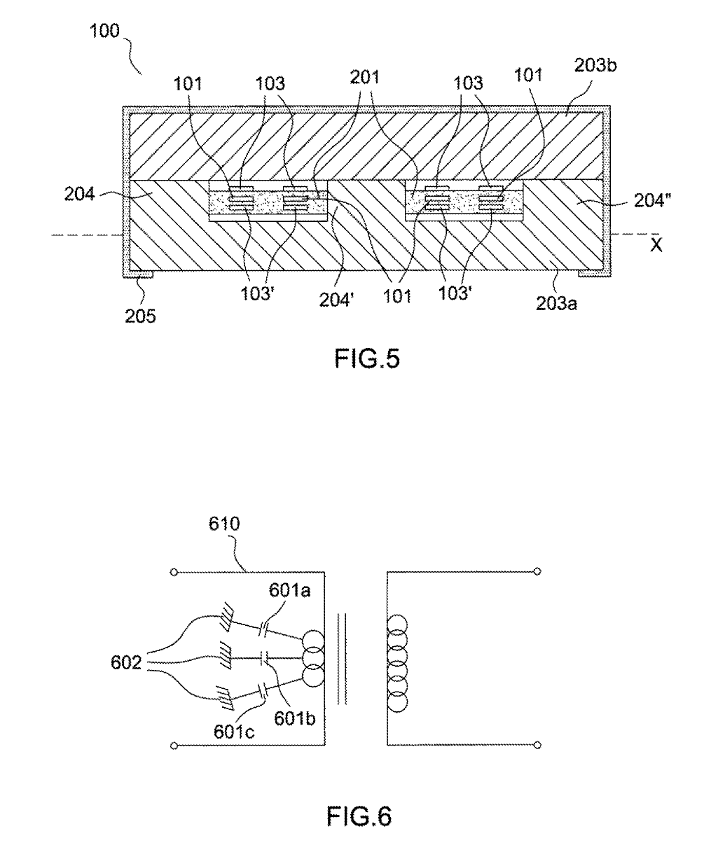

FIG. 5, a view in cross section of the transformer of FIG. 4;

FIG. 6, an illustration of a second embodiment comprising compensating capacitors,

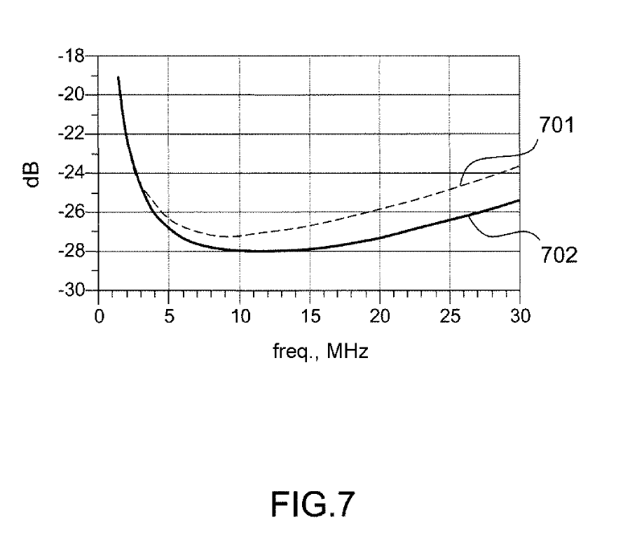

FIG. 7, an illustration, via a graph, of the effect on the impedance matching that is produced by adding compensating capacitors.

The same references in different figures indicate the same elements.

FIG. 1 shows a windings structure used in the power transformer according to the invention. In this example, the power transformer 100 comprises a winding 101 for the primary circuit flanked by two half-windings 103, 103′ belonging to the secondary circuit. Each winding 101, 103, 103′ is a track printed in a layer of multilayer printed circuit 201, two adjacent layers comprising a winding being separated by at least one thickness E1, E2 of dielectric substrate. To clarify FIG. 1, the substrate separating the conductive layers is not shown. The half-windings 103, 103′ of the secondary circuit are connected by one or more metalized vias 107. The turns of the winding 101 of the primary circuit are placed substantially parallel to and opposite to the turns of the half-windings 103, 103′ of the secondary circuit in order to obtain an efficient coupling between the primary circuit and the secondary circuit of the power transformer 100. Moreover, since the layer C2 in which the winding 101 of the primary circuit is printed is flanked by two layers C1, C3 on which the half-windings 103, 103′ of the secondary circuit are printed, the magnetic losses are minimized.

FIG. 2 shows a view in perspective of a printed circuit used in a transformer according to the invention.

The transformer according to the invention comprises a multilayer printed circuit 201 comprising the windings 101, 103, 103′ as shown in FIG. 1. The printed circuit 201 comprises a central orifice 202 around which the windings 101, 103, 103′ are printed. In FIG. 2, only the first half-winding 103 of the secondary circuit can be seen, the winding 101 of the primary circuit and the second half-winding 103′ of the secondary circuit being printed in internal layers of the printed circuit 201.

FIG. 3a shows an example of a block of ferromagnetic material 203 forming part of the transformer according to the invention, the block being in two portions 203a, 203b shown separately in the figure.

In the example, the ferromagnetic block 203 comprises a first portion 203a in the shape of an extruded E and a second, parallelepipedal portion 203b the width 11 and the length 12 of which are substantially equal to those of the first portion 203a. In other words, the first portion 203a of the block 203 is a plate of which one side F1 is provided with three protuberances 204, 204′, 204″ that are substantially parallelepipedal and have the same dimensions being added to the thickness of the plate, a first protuberance 204 being placed, in the example, in the width 11 on a first edge B1 of the plate, a second protuberance 204′ being placed substantially at the center, the third protuberance 204″ being placed on the edge B2 opposite to the edge B1 of the first protuberance 204. The second portion 203b of the ferromagnetic block 203 is a plate having, in the example, substantially the same dimensions 11, 12 as the plate of the first portion 203a. In addition, unlike the plate of the first portion 203a, the second portion 203b of the ferromagnetic block 203 has no protuberances.

Thus, as illustrated in FIG. 3b, when one side F3 of the second portion 203b is placed beside the protuberances 204, 204′, 204″ of the first portion 203a, the block of ferromagnetic material 203 takes the form of a binocular block, that is to say, in the example, a substantially parallelepipedal block in which two distinct orifices 207, 207′ are made. The binocular shape of the ferromagnetic block 203 makes it possible to concentrate the magnetic-field lines in order to extend the band of operation of the transformer 100 to the lowest frequencies (of the order of 1 MHz). As a result, this shape of block 203 also makes it possible to improve the electromagnetic shielding of the transformer 100. This shielding can also be improved by the insertion of vias on the periphery of the printed circuit 201 and/or ground planes placed on either side of the windings 101, 103, 103′.

The two portions 203a, 203b of the ferromagnetic block 203 are made of ferrite of which the permeability p is fairly high (of the order of 700-1000) in order to ensure good operation for low frequencies. In the example, the two portions 203a, 203b of the ferromagnetic block 203 are held together simply by virtue of a metal rod 205 tightly holding the two portions 203a, 203b. According to another embodiment, bonding is used to hold the two portions 203a, 203b together.

FIG. 4 shows a view in perspective of a transformer according to the invention comprising the printed circuit of FIG. 2a in which the first portion 203a of the ferromagnetic block 203 is fitted. FIG. 5 shows a view of this transformer in cross section. The second protuberance 204′ of the plate is inserted into the central orifice 202 of the printed circuit 201 and the first protuberance 204 and third protuberance 204″, framing the windings of the printed circuit 201 on its sides, so that, when the second portion 203b of the block 203 is placed next to the first portion 203a, the ferromagnetic block 203 consisting of the two portions placed next to one another envelopes the printed circuit 201 and forms a magnetic core at the center of said circuit 201.

According to one embodiment of the transformer according to the invention, a thermal interface is plated onto the ferromagnetic block 203 in order to dissipate the calories caused by the magnetic losses inside said block 203.

Unlike a conventional planar power-supply transformer, the RF transformer according to the invention exploits the capacitive coupling between the primary winding 101 and secondary winding 103, 103′ (FIG. 1). Specifically, at the operating frequencies, that is to say at radiofrequency, a capacitive coupling appears between the turns of the windings 101, 103 and 101, 103′ placed facing one another, this capacitive coupling making it possible to improve the behavior of the transformer (the impedances of the windings) notably compared with the power transistors that are optionally connected at the input of the transformer according to the invention, particularly at the highest frequencies. The widths of the turns (that is to say of the printed tracks) are notably chosen as a function of the thicknesses E1, E2 (FIG. 1) of the layers of dielectric substrate, since the greater the thickness E1, E2 of substrate, the more the turns of the windings 101, 103, 103′ have to be widened to promote the capacitive coupling between the windings 101, 103 and 101, 103′. The power of the current running through the transformer is also a variable taken into account in the choice of the width of the turns.

FIG. 6 shows an illustration of a second embodiment comprising compensating capacitors. In the example, the first connection of a capacitor 601a, 601b, 601c is connected to each turn of the winding 101 of the primary circuit. The second connection of each of these capacitors 601a, 601b, 601c is linked to an electric ground 602. The addition of these capacitors 601a, 601b, 601c makes it possible to improve the matching of the transformer to its environment, for example the matching to power transistors connected to the transformer, particularly in the high frequencies, in the example in a frequency band from 15 MHz to 50 MHz. These capacitors 601a, 601b, 601c connected in parallel between the winding in question and the ground compensate in a novel manner for the imperfections of the transformer by creating a transmission line with the inductive component of the winding in question. They may optionally be replaced by various capacitive elements, and even more complex components (for example LC networks) in order to more favorably modify the behavior of the transformer in the band, notably at the highest frequencies.

According to another embodiment, in order to improve the control of the impedances, additional capacitive elements can be connected in parallel to the primary winding or, as proposed by patent U.S. Pat. No. 5,015,972 mentioned above in the preamble, between the turns of one and the same winding.

FIG. 7 illustrates, through a graph, the effect produced by the addition of compensating capacitors 601a, 601b, 601c connected between the turns of the primary winding 101 and the electric ground 602 (FIG. 6). A first curve 701 shows the evolution of the reflection coefficient S11 of a transformer with no compensating capacitor as a function of the frequency of the signal entering the transformer. A second curve 702 shows the evolution of the reflection coefficient S11 of a transformer comprising a compensating capacitor as a function of the frequency of the signal entering the transformer. The matching of the transformer is improved, particularly at the high frequencies.

One advantage of the transformer according to the invention is its low manufacturing cost, notably because the multilayer printed circuit used can be a standard, low-cost circuit. Moreover, the structure of the transformer according to the invention makes it possible to simplify the connection of components to the primary circuit and to the secondary circuit. Specifically, since the transformer is formed based on a multilayer printed circuit, no fitting operation (that is to say manual brazing) is required to integrate the transformer into an existing circuit.

Moreover, the RF power transformer according to the invention limits the magnetic coupling losses as compared with the structure proposed in patent U.S. Pat. No. 5,015,972 cited in the preamble, notably by virtue of its windings structure in which the primary circuit is flanked above and below by the secondary circuit.

1. A high-frequency power transformer comprising a primary winding and a secondary winding, said power transformer being produced in a multilayer printed circuit board comprising at least the following stacked layers in succession:
a first conductive layer;
a first layer of dielectric substrate;
a second conductive layer;
a second layer of dielectric substrate; and
a third conductive layer,
the primary winding being formed by turns printed in the second conductive layer,
the secondary winding being formed by a first half-winding printed in the first conductive layer,
this first half-winding being connected to a second half-winding printed in the third conductive layer,
the turns of the secondary winding being placed opposite to the turns of the primary winding,
the widths of the turns of the windings being chosen as a function of the thicknesses of the layers of dielectric substrate, of the instantaneous-frequency band and of the power of the high-frequency signal passing through the transformer,
said board being tightly held above and below by two plates of ferromagnetic material assembled to form a binocular block,
the first portion of said block being formed of an extruded E,
the central branch of the E being inserted into the orifice formed at the center of the printed board, thus forming a magnetic core at the center of the windings,
the second portion of said block being formed of a substantially flat plate.

2. The radiofrequency power transformer as claimed in claim 1, wherein at least one capacitive element is connected between at least one turn of one of the windings and an electric ground.

3. The radiofrequency power transformer as claimed in claim 2, wherein said at least one capacitive element is connected between at least one turn of the primary winding and the electric ground.

4. The radiofrequency power transformer as claimed in claim 1 wherein an orifice is formed at the center of the printed board, the ferromagnetic block comprising at least two portions assembled to form a binocular block, each portion of said block occupying one side of the printed board, the first portion of said block being formed of an extruded E, the central branch of the E being inserted into the orifice formed at the center of the printed board, thus forming a magnetic core at the center of the windings, the second portion of said block being formed of a substantially flat plate.

5. The radiofrequency power transformer as claimed in claim 1, wherein said power transformer is capable of operating for instantaneous-frequency band signals of between 1 MHz and 50 MHz.

6. A radiofrequency power transmitter board, comprising a transformer as claimed in claim 1.

7. A radiofrequency power transmitter board, comprising a transformer as claimed in claim 2.

8. A radiofrequency power transmitter board, comprising a transformer as claimed in claim 3.

9. A radiofrequency power transmitter board, comprising a transformer as claimed in claim 4.

10. A radiofrequency power transmitter board, comprising a transformer as claimed in claim 5.
